(19) United States
(12) Patent Application Publication
(10) Pub. No.: US 2026/0328088 A1
(43) Pub. Date: Oct. 22, 2026

(54) DOWNHOLE DETERMINATION OF RATE OF PENETRATION (ROP) DURING WELL OPERATIONS IN WELL SYSTEMS

(71) Applicant: Halliburton Energy Services, Inc., Houston, TX (US)

(72) Inventors: Boguslaw Wiecek, Houston, TX (US); Rebecca Jachmann, Houston, TX (US)

(21) Appl. No.: 19/184,590

(22) Filed: Apr. 21, 2025

(51) Int. Cl. E21B 47/12; E21B 47/26; G01V 3/38

(52) U.S. Cl. CPC E21B 47/12; E21B 47/26; G01V 3/38

(57) ABSTRACT

Systems, methods, and apparatus, including computer programs encoded on computer-readable media, for determining a downhole rate of penetration (ROP) in a well system. First nuclear magnetic resonance (NMR) porosity data may be determined based on first NMR measurements performed downhole using an NMR tool of the well system. First porosity tool data may be determined based on first porosity tool measurements performed downhole using a porosity tool. A first candidate ROP may be selected and a first corrected NMR porosity data may be determined based on the selected first candidate ROP and the first NMR porosity data. It may be determined whether the first corrected NMR porosity data and the first porosity tool data minimize a first porosity error within an error tolerance. The first candidate ROP may be selected as the downhole ROP in response to determining the first porosity error is minimized within the error tolerance.

### TECHNICAL FIELD

The present invention relates generally to oil and gas systems and services, and more specifically to downhole determination of a rate of penetration (ROP) during well operations in well systems.

### BACKGROUND

The oil and gas services industry uses various types of well equipment and tools in well systems at well sites. Well systems may use nuclear magnetic resonance (NMR) tools for NMR logging of the subsurface formation of a well for hydrocarbon reservoir evaluation. For example, the NMR logging may indicate various properties of the subsurface formation, such as the volume (e.g., porosity) and distribution (e.g., permeability) of the rock pore space, the rock composition, the type and quality of the fluids (e.g., water and hydrocarbons), and hydrocarbon producibility. NMR tools are typically not used downhole to determine rate of penetration (ROP) downhole. ROP is typically determined by the surface equipment at the well site. However, when the ROP measurement derived at the surface is provided downhole for use by one or more downhole tools or devices, the ROP measurement typically becomes stale and therefore inaccurate. Also, sending ROP measurements from the surface to the downhole devices too frequently can interfere with other critical transmissions and communications of the well system.

### BRIEF DESCRIPTION OF THE DRAWINGS

FIG. 1 depicts a schematic diagram of an example well system including a nuclear magnetic resonance (NMR) tool and another porosity measurement tool, such as a neutron tool, according to some implementations.

FIG. 2 depicts a workflow of example operations for determining a downhole rate of penetration (ROP) based on downhole NMR and other porosity tool measurements, such as neutron tool measurements, according to some implementations.

FIG. 3 depicts a workflow of example operations for determining a downhole ROP based on a collection of downhole NMR measurements and other porosity tool measurements, such as neutron tool measurements, according to some implementations.

FIG. 4 depicts a workflow of example operations for determining a downhole ROP based on a received surface ROP or a candidate ROP derived based on downhole NMR and other porosity tool measurements, such as neutron tool measurements, according to some implementations.

FIG. 5 depicts a workflow of example operations for determining a downhole ROP based on a received surface ROP or candidate ROPs determined from a collection of downhole NMR and other porosity tool measurements, such as neutron tool measurements, according to some implementations.

FIG. 6 is a flowchart of example operations for downhole ROP determination in a well system, according to some implementations.

FIG. 7 depicts an example computer system of a well system for processing NMR and neutron measurements, according to some implementations.

FIG. 8 shows an example well system that includes an NMR tool in a wireline logging environment, according to some implementations.

FIG. 9 shows an example well system that includes an NMR tool in a drilling environment, according to some implementations.

FIG. 10 is a diagram of an example NMR magnet and antenna(s) configuration, according to some implementations.

### DESCRIPTION

The description that follows includes example systems, methods, techniques, and program flows that describe aspects of the disclosure. However, it is understood that this disclosure may be practiced without these specific details. For instance, this disclosure refers to certain well systems, devices, or tools in illustrative examples. Aspects of this disclosure can be instead applied to other types of well systems, devices, and tools. In other instances, well-known instruction instances, protocols, structures, and techniques have not been shown in detail to avoid confusion.

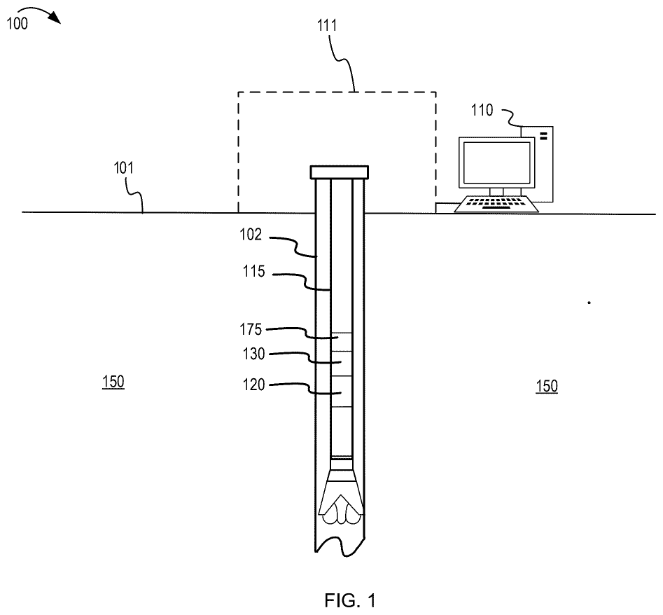

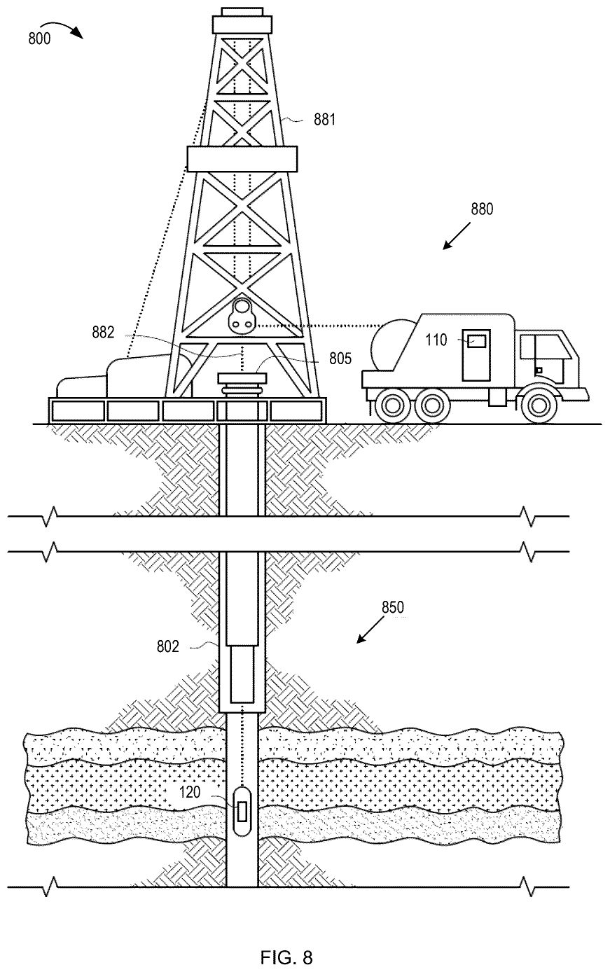

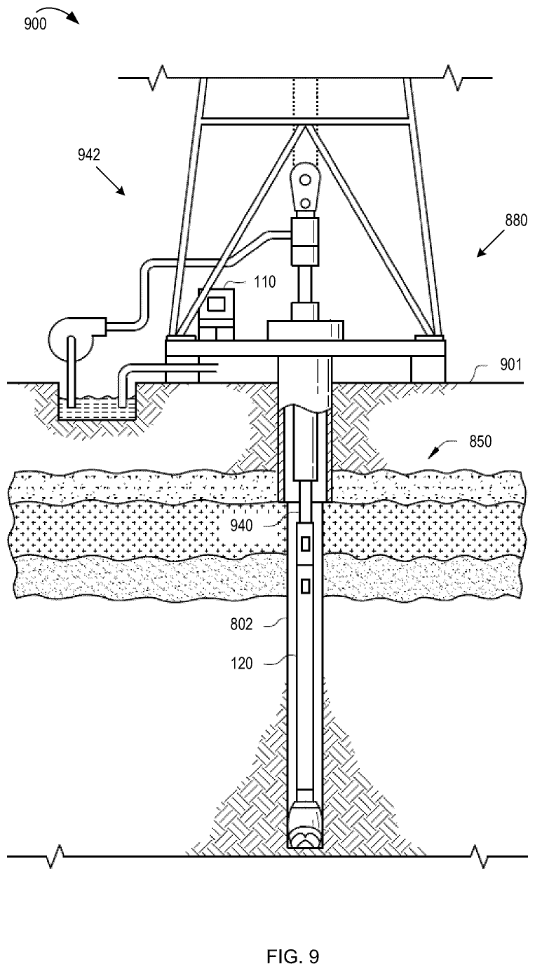

FIG. 1 depicts a schematic diagram of an example well system 100 including a nuclear magnetic resonance (NMR) tool and another porosity measurement tool, such as a neutron tool, according to some implementations. In some implementations, the well system 100 may include a wellbore 102, surface equipment and tools 111, such as the computer system 110, and downhole equipment and tools, such as the NMR tool 120, the neutron tool 130, and the downhole computing device 175. The well system 100 may also include a work string 115 (or drill string or other type of well tubing or pipe) that can lower the NMR tool 120 and the neutron tool 130 downhole into the wellbore 102 (or borehole). Additional non-limiting examples of well systems that can implement the NMR tool 120 and the neutron tool 130 are described below in FIGS. 8-9. FIG. 1 shows a portion of the wellbore 102 and well system 100 for simplicity. It is noted that the well system 100 may include additional equipment, devices, tools and other components at the surface 101 or downhole that are not shown for simplicity. The well system 100 may use the NMR tool 120 for NMR logging of the subsurface formation 150 of the wellbore 102 for hydrocarbon reservoir evaluation. For example, the NMR logging may indicate various properties of the subsurface formation 150, such as the volume (e.g., porosity) and distribution (e.g., permeability) of the rock pore space, the rock composition, the type and quality of the fluids (e.g., water and hydrocarbons), and hydrocarbon producibility, among others. The neutron tool 130 may also be used to determine properties of the subsurface formation, such as porosity. It is noted that, in some implementations, other types of porosity measurement tools or porosity tools may be used in the well system 100 in addition to, or instead of, the neutron tool 130 to measure, derive, or infer the porosity of the subsurface formation. Therefore, the NMR measurements (and other NMR data obtained from the NMR logging) and the neutron measurements can be used for well site planning, well drilling, hydrocarbon recovery operations, and other well operations.

In some implementations, the well system 100 may obtain NMR measurements from the NMR tool 120 and neutron measurements from the neutron tool 130. In some implementations, the NMR tool 120 and the neutron tool 130 may be used in a logging while drilling (LWD) or a measurement while drilling (MWD) context or while performing other well operations. During well operations, such as LWD or MWD, the work string 115 (or drill string) may be moved downhole at a rate of penetration (ROP). The ROP is typically measured at the surface by the surface equipment 111. The surface ROP measurement can be sent downhole for use by downhole well devices or tools. However, the surface ROP measurement is typically not sent downhole regularly, and thus the ROP measurement may become stale over time. In some implementations, one or more downhole devices or tools may use NMR measurements and neutron measurements that are performed downhole to determine a downhole ROP. The one or more downhole device may include at least one of the downhole computing device 175, the NMR tool 120, and the neutron tool 130. The downhole ROP can be derived as often as the ROP measurement is needed by the downhole well devices and tools. For example, the downhole ROP may be used for NMR operations. As another example, the downhole ROP may be used for accurate downhole autonomous steering during drilling operations.

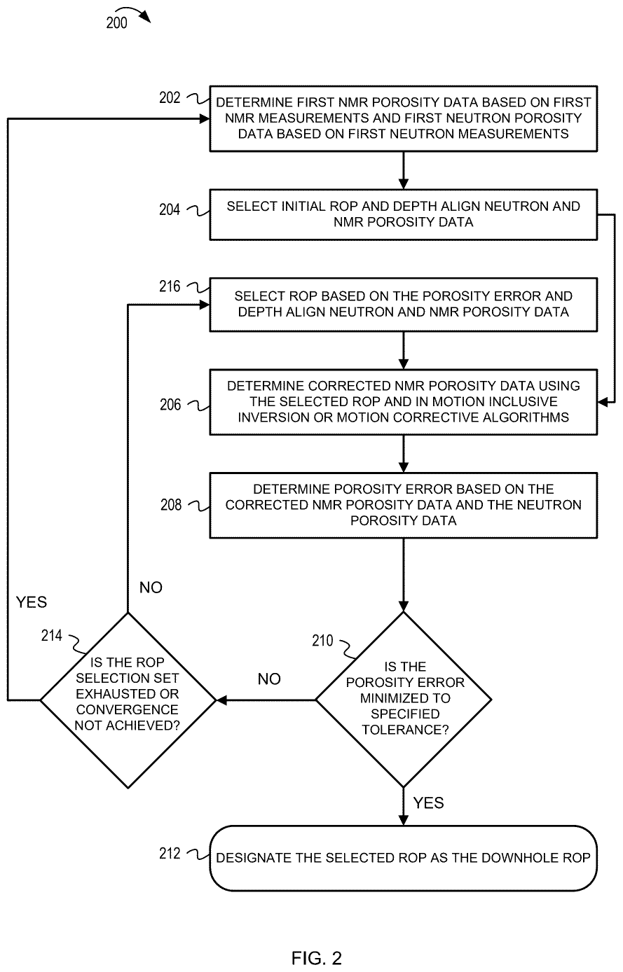

FIG. 2 depicts a workflow 200 of example operations for determining a downhole ROP based on downhole NMR and other porosity tool measurements, such as neutron tool measurements, according to some implementations. In some implementations, the NMR tool 120 may perform a first set of NMR measurements, which may be referred to as first NMR measurements, and the neutron tool 130 may perform a first set of neutron measurements, which may be referred to as first neutron measurements. For example, the NMR tool 120 and the neutron tool 130 may perform the measurements during LWD or MWD or while performing other well operations. In some implementations, a downhole device (or multiple downhole devices) of the well system 100 (e.g., one or more devices located downhole in the work string 115) may perform the remaining operations described below in FIG. 2. The downhole device or the multiple downhole devices may include at least one of the downhole computing device 175, the NMR tool 120, and the neutron tool 130. In some implementations, the downhole device of the well system 100 may determine first NMR porosity data based on the first NMR measurements, and first neutron porosity data based on the first neutron measurements (block 202). For example, for NMR, the NMR measurements may include obtaining NMR echo data (e.g., NMR echo train data), and performing an inversion operation on the NMR echo data to determine the properties of the subsurface formation, including porosity. The neutron measurements or other tool measurements may also be processed to determine properties of the subsurface formation, such as porosity. It is noted that, in some implementations, other types of porosity measurement tools or porosity tools may be used in the well system 100 in addition to, or instead of, the neutron tool 130 to measure, derive, or infer the porosity of the subsurface formation.

In some implementations, the downhole device may select an initial ROP, which may also be referred to as a first candidate ROP, and may depth align the first NMR porosity data and the first neutron porosity data (block 204). In some implementations, the initial ROP (or the first candidate ROP) may be selected based on a last known ROP or a predetermined ROP. In some implementations, the initial ROP may be derived based on a last known or last calculated porosity error. In one example, the last known ROP or the predetermined ROP may be a surface ROP. In another example, the last known ROP or the predetermined ROP may be a last calculated ROP. In another example, the predetermined ROP may be an ROP that is selected as a starting point, such as an ROP of zero or an ROP having a low value, or a random ROP value that is selected as a starting point. In some implementations, the first NMR porosity data and the first neutron porosity data may be depth aligned based on the initial ROP (or the first candidate ROP). For example, since timing information is known for the NMR and neutron measurements, and the distance between the NMR tool 120 and the neutron tool 130 is known, the first NMR porosity data and the first neutron porosity data may be depth aligned based on the initial ROP.

In some implementations, the downhole device may determine corrected NMR porosity data using the selected initial ROP (or the first candidate ROP) and in motion inclusive inversion or motion correction algorithms (block 206). For example, the first NMR porosity data may be corrected using the initial ROP and in motion inclusive inversion or motion correction algorithms. In some implementations, the downhole device may determine a first porosity error based on the corrected NMR porosity data and the first neutron porosity data (block 208). In some implementations, the downhole device may derive a first porosity error from the difference between the corrected NMR porosity data and the first neutron porosity data. For example, the first porosity error (which may also be referred to as a porosity delta or porosity difference) may be determined by the absolute value of the difference between the corrected NMR porosity data and the first neutron porosity data, as further described in the algorithm shown below.

In some implementations, the downhole device may determine whether the first porosity error is minimized within a specified error tolerance by the corrected NMR porosity data and the first neutron porosity data (block 210). For example, the first porosity error is minimized within the specified error tolerance when the first porosity error is less than a porosity error threshold. In one example, the porosity error threshold may be a value close to zero or approximately zero. In another example, the first porosity error is minimized within the specified error tolerance when the first porosity error is less than other porosity errors derived from other NMR and neutron measurements. In some instances, the first porosity error may be minimized or be approximately zero when measurements are taken in sections of the subsurface formation that are homogenous and/or when the measurements are taken in horizontal sections of the wellbore (i.e., when the depth associated with the NMR and neutron tools is approximately the same). Since the NMR tool 120 and the neutron tool 130 are located in different parts of the work string 115, the depth that the measurements are taken at any particular time are taken at different depths, unless the section of the subsurface formation is a horizontal section. Therefore, when measurements are taken in non-horizontal sections of the wellbore or when the subsurface formation is heterogenous, the NMR and neutron porosity data will likely be different and thus the resulting porosity error will not be minimized. In some implementations, to account for the different depths and heterogenous subsurface formation sections, the NMR and neutron porosity data is depth aligned, as described above in block 204. It is noted, however, that in some implementations the NMR and neutron porosity data may not be depth aligned in the operations described in FIG. 2. For example, the NMR and neutron measurements may be assumed to be depth aligned (e.g., measurements taken in a horizontal section of the well), or the NMR tool 120 and the neutron tool 130 may be located at approximately the same location/depth (e.g., approximately the same location in the work string) and any variations may be assumed to be negligible.

In some implementations, if the corrected NMR porosity data and the first neutron porosity data minimize the first porosity error within the error tolerance, the downhole device may select or designate the selected initial ROP (or the selected first candidate ROP) as the downhole ROP (block 212). The downhole ROP may also be referred to as the true downhole ROP. In some implementations, the NMR tool 120 may continue performing NMR measurements and the neutron tool 130 may continue performing neutron measurements. The downhole device may continue to perform the operations described in FIG. 2 continuously or periodically to update the downhole ROP to continue to use an accurate ROP and continue to transmit an accurate ROP to other downhole devices to perform downhole well operations.

In some implementations, if the corrected NMR porosity data and the first neutron porosity data do not minimize the first porosity error within the error tolerance, the downhole device may determine whether the ROP selection set is exhausted (block 214) or, if the ROP is calculated from the porosity error, the convergence is not achieved. In some implementations, the ROP selection set may be another known or predetermined ROP or previously calculated ROP (e.g., based on a porosity error) that can be used to try to minimize the porosity error. In some implementations, if the initial ROP was selected as a low ROP value or an ROP of zero, the ROP selection set may be a sequence of low ROP values, and the downhole device may select a next low ROP value in the sequence of low ROP values. In some implementations, if the ROP is calculated from the porosity error, the convergence is achieved if the calculated ROP stops changing within a specified convergence factor, and the convergence is not achieved if the calculated ROP changes outside the specified convergence factor. In some implementations, if the ROP selection set has been exhausted or convergence not achieved, the process loops back to block 202, and the operations of FIG. 2 restart with new first NMR and neutron measurements. In some implementations, if the ROP selection set has not been exhausted or convergence is achieved, another ROP value is selected as the second candidate ROP. In some implementations, the second candidate ROP may be determined based on the first porosity error and the NMR and neutron porosity data may be depth aligned based on the second candidate ROP (block 216). The operations of blocks 206-210 may be repeated using the second candidate ROP (and any additional candidates ROP if the process continues to loop, e.g., third candidate ROP, fourth candidate ROP, etc.). For example, a second corrected NMR porosity data may be determined based on the second candidate ROP and in motion inclusive inversion or motion correction algorithms (block 206). For example, the first NMR porosity data may be corrected using the second candidate ROP and in motion inclusive inversion or motion correction algorithms. In some implementations, the downhole device may determine a second porosity error based on the second corrected NMR porosity data and the first neutron porosity data (block 208). The downhole device may derive a second porosity error from the difference between the second corrected NMR porosity data and the first neutron porosity data. In some implementations, the downhole device may determine whether the second porosity error is minimized within the specified error tolerance by the second corrected NMR porosity data and the first neutron porosity data (block 210). In some implementations, if the second corrected NMR porosity data and the first neutron porosity data minimize the second porosity error within the error tolerance, the downhole device may select or designate the selected second candidate ROP (or the last selected ROP) as the downhole ROP (block 212). Otherwise, the process loops back and performs the operation of block 214, as described above.

A non-limiting example of an algorithm for determining the downhole ROP (as described in FIG. 2) is described below. The porosity error or Delta_PU can be determined as shown in the following.

$${Delta\_PU}_{q} = abs ( Nuetron Porosity - NMR Porosity ) \qquad ( Equation 1.1 )$$

The determined downhole ROP, which may also be referred as the true ROP, ROPₜᵣᵤₑ, of the NMR tool 120 is the v_{q} (i.e., the NMR tool ROP) that has the minimum Delta_PU_{q}. ROPₜᵣᵤₑ can be used to calculate the true spectrum Xₜᵣᵤₑ as shown below.

$${X}_{true} = {A ( {ROP}_{true} )}^{- 1} {Y}_{m e a s u r e d} \qquad ( Equation 1.2 )$$

As shown above, after verifying the determined downhole ROP is the true downhole ROP, the downhole ROP can be used to determine a true spectrum (or a more accurate spectrum) associated with the subsurface formation, which may be used to determine one or more properties of the subsurface formation. For example, the true spectrum (e.g., Xₜᵣᵤₑ) can be interpreted to determine porosity, free fluid porosity, macro porosity, micro porosity, differential oil/gas/water, diffusivity, hydrocarbon producibility, or permeability of formation, among others. The properties of the subsurface formation can be used for well site planning, hydrocarbon recovery operations, and other well operations. In some implementations, well operations associated with the subsurface formation (e.g., such as drilling the well or hydrocarbon recovery) can be determined or modified, or parameters or features or attributes of the well operation can be determined or modified, based on the determined properties of the subsurface formation.

In some implementations, the determined downhole ROP can be communicated to one or more downhole well devices and tools that can utilize the downhole ROP. For example, the determined downhole ROP can be communicated to an autonomous steering device that controls autonomous steering for drilling operations or for other well operations.

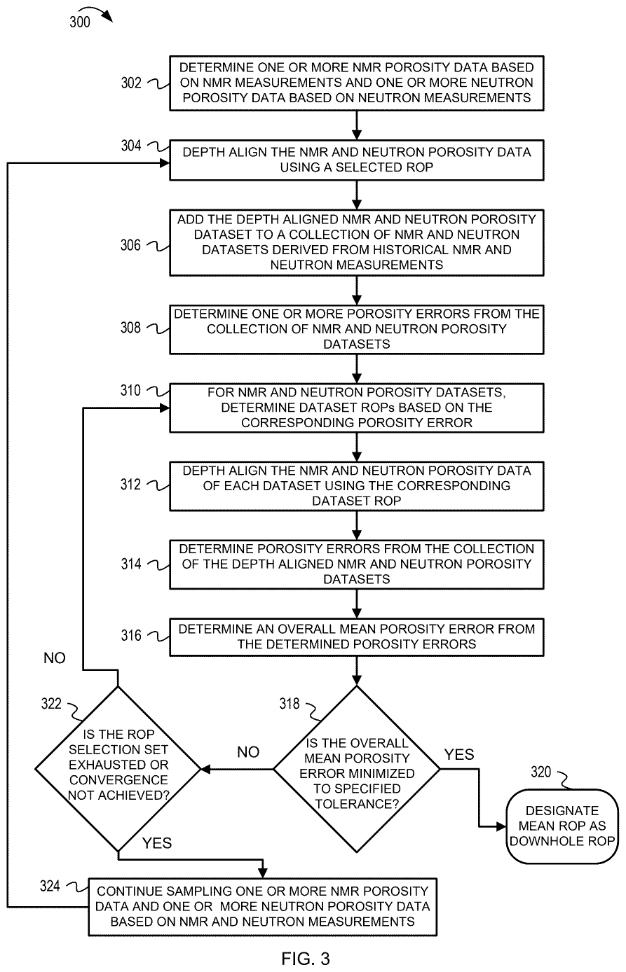

FIG. 3 depicts a workflow 300 of example operations for determining a downhole ROP based on a collection of downhole NMR and other porosity tool measurements, such as neutron tool measurements, according to some implementations. In some implementations, the NMR tool 120 may perform multiple sets of NMR measurements, and the neutron tool 130 may perform multiple sets of neutron measurements in a collection of measurements. For example, the NMR tool 120 and the neutron tool 130 may perform the collection of measurements during LWD or MWD or while performing other well operations. In some implementations, a downhole device (or multiple downhole devices) of the well system 100 (e.g., one or more devices located downhole in the work string 115) may perform the remaining operations described below in FIG. 3. The downhole device or the multiple downhole devices may include at least one of the downhole computing device 175, the NMR tool 120, and the neutron tool 130. In some implementations, the downhole device of the well system 100 may determine one or more NMR porosity data based on the one or more NMR measurements, and one or more neutron porosity data based on the one or more neutron measurements (block 302). For example, for NMR, the NMR measurements may include obtaining NMR echo data (e.g., NMR echo train data), and performing an inversion operation on the NMR echo data to determine the properties of the subsurface formation, including porosity. The neutron measurements may also be processed to determine properties of the subsurface formation, such as porosity. It is noted that, in some implementations, other types of porosity measurement tools or porosity tools may be used in the well system 100 in addition to, or instead of, the neutron tool 130 to measure, derive, or infer the porosity of the subsurface formation.

In some implementations, the downhole device may depth align the one or more NMR porosity data and the one or more neutron porosity data based on a selected initial ROP (block 304). In some implementations, during the initial phase, the selected ROP may be referred to as an initial ROP or a first candidate ROP. In some implementations, the initial ROP (or the first candidate ROP) may be selected based on a last known ROP or a predetermined ROP. In some implementations, the initial ROP may be derived based on a last known or last calculated porosity error. In one example, the last known ROP or the predetermined ROP may be a surface ROP. In another example, the last known ROP or the predetermined ROP may be a last calculated ROP. In another example, the predetermined ROP may be an ROP that is selected as a starting point, such as an ROP of zero or an ROP having a low value, or a random ROP value that is selected as a starting point. In some implementations, the one or more NMR porosity data and the one or more neutron porosity data may be depth aligned based on the initial ROP (or the first candidate ROP). For example, since timing information is known for the NMR and neutron measurements, and the distance between the NMR tool 120 and the neutron tool 130 is known, the one or more NMR porosity data and the one or more neutron porosity data may be depth aligned based on the initial ROP or the first candidate ROP.

In some implementations, the depth aligned NMR porosity and neutron porosity dataset is added to a collection of NMR porosity and neutron porosity datasets derived from historical NMR and neutron measurements (block 306). The historical NMR and neutron measurements may be the latest measurements that have been performed within a specified or predefined time period. For example, the historical NMR and neutron measurements may be the latest measurement performed within the last specified number of days (e.g., two days or four days) or within the last specified number of weeks (e.g., one week or two weeks). It is noted, however, that the historical NMR and neutron measurements may be obtained from any time period as needed.

In some implementations, one or more porosity errors may be determined from the collection of NMR and neutron porosity datasets (block 308). For example, a porosity error may be derived from each NMR and neutron porosity datasets. In some implementations, each porosity error may be derived from the difference between the NMR porosity data and the neutron porosity data from each dataset. For example, the porosity error may be determined by the absolute value of the difference between the NMR porosity data and the neutron porosity data. In some implementations, for the NMR and neutron porosity datasets, dataset ROPs (or second candidate ROPs) may be determined based on the porosity error associated with the corresponding dataset (block 310). In some implementations, the NMR and neutron porosity data of each dataset may be depth aligned using the corresponding dataset ROP (block 312). In some implementations, multiple porosity errors are determined from the collection of the depth aligned NMR and neutron porosity datasets (block 314). The depth aligned NMR and neutron porosity datasets may also be referred to as the ROP corrected NMR and neutron porosity datasets. For example, each depth aligned NMR and neutron porosity dataset may be used to calculate a porosity error. In some implementations, an overall mean porosity error may be determined from the multiple porosity errors that are derived from the collection of the depth aligned NMR and neutron porosity datasets (block 316). The overall mean porosity error may be calculated using one or more techniques. For example, the overall mean porosity error may be calculated using at least one of the mean, log mean, or the geometric mean, among others, of the multiple porosity errors that are derived from the collection. The first iteration of the mean porosity error may be referred to as a first candidate mean porosity error or the initial mean porosity error. As described above, in some implementations, to account for the different depths and heterogenous subsurface formation sections, the NMR and neutron porosity datasets may be depth aligned as described above in blocks 304 and 312. It is noted, however, that in some implementations the NMR and neutron porosity data may not be depth aligned in the operations described in FIG. 3. For example, the NMR and neutron measurements may be assumed to be depth aligned (e.g., measurements taken in a horizontal section of the well), or the NMR tool 120 and the neutron tool 130 may be located at approximately the same location/depth (e.g., approximately the same location in the work string) and any variations may be assumed to be negligible.

In some implementations, the downhole device may determine whether the determined overall mean porosity error is minimized within a specified error tolerance (block 318). For example, the mean porosity error is minimized within the specified error tolerance when the mean porosity error is less than a porosity error threshold. In one example, the porosity error threshold may be a value close to zero or approximately zero. In some implementations, if the mean porosity error is minimized within the error tolerance, the downhole device may select or designate a mean ROP as the downhole ROP (block 320). The downhole ROP may also be referred to as the true downhole ROP. In some implementations, the mean ROP may be derived by calculating the mean of the different dataset ROPs that were determined in block 310. For example, the mean ROP may be calculated using at least one of the mean, log mean, or the geometric mean, among others, of the multiple dataset ROPs that are derived from the collection of datasets. The first iteration of the mean ROP may be referred to as the first candidate mean ROP or the initial mean ROP. In some implementations, the NMR tool 120 may continue performing NMR measurements and the neutron tool 130 may continue performing neutron measurements. The downhole device may continue to perform the operations described in FIG. 3 continuously or periodically to update the downhole ROP to continue to use an accurate ROP and continue to transmit an accurate ROP to other downhole devices to perform downhole well operations.

In some implementations, if the mean porosity error is not minimized within the error tolerance, the downhole device may determine whether the ROP selection set is exhausted (block 322) or, if the ROP is calculated from the porosity error, the convergence is not achieved. In some implementations, the ROP selection set may be additional dataset ROPs that may be derived from additional NMR and neutron measurements, or may be additional dataset ROPs that are derived from additional NMR and neutron measurements that were not included in the initial collection of datasets. In some implementations, if the ROP selection set has been exhausted or convergence was not achieved, the downhole device may continue sampling NMR porosity data based on NMR measurements and neutron porosity data based on neutron measurements (block 324), and then the process loops back to block 304, and the operations of FIG. 3 restart with new NMR and neutron porosity data. In some implementations, if the ROP selection set has not been exhausted or convergence was achieved, one or more additional ROP dataset ROPs from the ROP selection set are added to the collection of datasets, and the operations of blocks 310-318 are repeated using an updated mean porosity error and mean ROP. During a second iteration (if there is a second iteration), the updated mean porosity error may be referred to as the second candidate mean porosity error and the updated mean ROP may be referred to as the second candidate mean ROP. During a third iteration (if there is a third iteration), the updated mean porosity error may be referred to as the third candidate mean porosity error and the updated mean ROP may be referred to as the third candidate mean ROP, and so on for additional iterations.

In one non-limiting example, as described in FIG. 2, the porosity error or Delta_PU can be determined as shown in Equation 1.1 above. The determined downhole ROP, which may also be referred as the true ROP, ROPₜᵣᵤₑ, of the NMR tool 120 is the v_{q} (i.e., the NMR tool ROP) that has the minimum Delta_PU_{q}. ROPₜᵣᵤₑ can be used to calculate the true spectrum Xₜᵣᵤₑ as shown in Equation 1.2 above. After verifying the determined downhole ROP is the true downhole ROP, the downhole ROP can be used to determine a true spectrum (or a more accurate spectrum) associated with the subsurface formation, which may be used to determine one or more properties of the subsurface formation. For example, the true spectrum (e.g., Xₜᵣᵤₑ) can be interpreted to determine porosity, free fluid porosity, macro porosity, micro porosity, differential oil/gas/water, diffusivity, hydrocarbon producibility, or permeability of formation, among others. The properties of the subsurface formation can be used for well site planning, hydrocarbon recovery operations, and other well operations. In some implementations, well operations associated with the subsurface formation (e.g., such as drilling the well or hydrocarbon recovery) can be determined or modified, or parameters or features or attributes of the well operation can be determined or modified, based on the determined properties of the subsurface formation.

In some implementations, the determined downhole ROP can be communicated to one or more downhole well devices and tools that can utilize the downhole ROP. For example, the determined downhole ROP can be communicated to an autonomous steering device that controls autonomous steering for drilling operations or for other well operations.

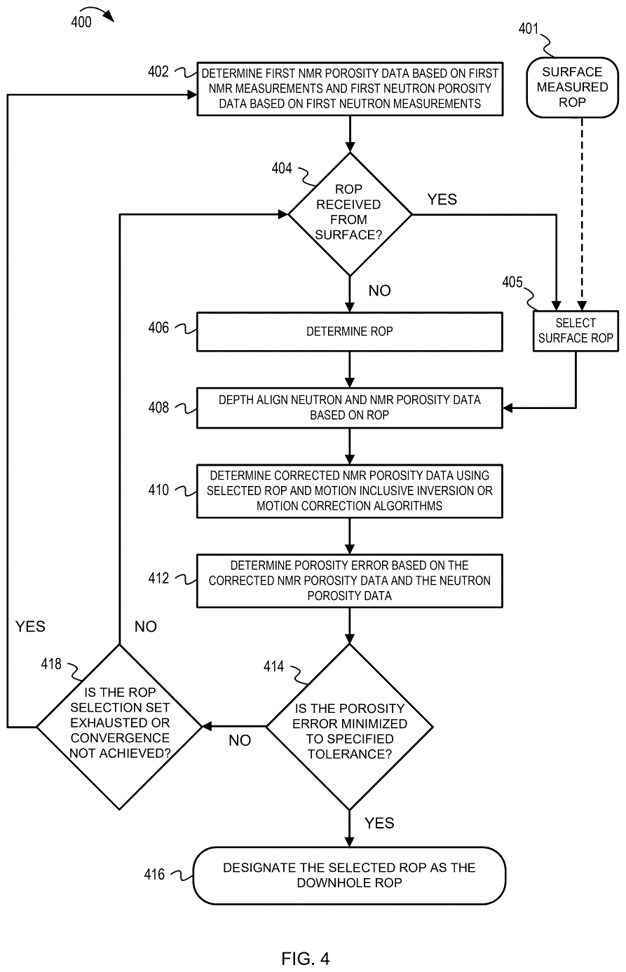

FIG. 4 depicts a workflow 400 of example operations for determining a downhole ROP based on a received surface ROP or candidate ROP derived based on downhole NMR and porosity tool measurements, such as neutron tool measurements, according to some implementations. In some implementations, a downhole device of the well system 100 may obtain a surface ROP from the surface equipment of the well system (block 401). For example, the surface equipment may calculate a surface ROP based on the movement of the work string 115 downhole during LWD or MWD or while performing other well operations. As described above in FIGS. 2-3, the downhole device may include at least one of the downhole computing device 175, the NMR tool 120, and the neutron tool 130. The NMR tool 120 and the neutron tool 130 may perform measurements during the well operations. In some implementations, the downhole device may determine first NMR porosity data based on the first NMR measurements, and first neutron porosity data based on the first neutron measurements (block 402). For example, for NMR, the NMR measurements may include obtaining NMR echo data (e.g., NMR echo train data), and performing an inversion operation on the NMR echo data to determine the properties of the subsurface formation, including porosity. The neutron measurements may also be processed to determine properties of the subsurface formation, such as porosity. It is noted that, in some implementations, other types of porosity measurement tools or porosity tools may be used in the well system 100 in addition to, or instead of, the neutron tool 130 to measure, derive, or infer the porosity of the subsurface formation.

In some implementations, the downhole device may determine whether a surface ROP was received (block 404). In some implementations, if the downhole device receives the surface ROP, the downhole device select the surface ROP as an initial ROP, which may also be referred to as a first candidate ROP (block 405). If a surface ROP is not received, the downhole device may determine an initial ROP (or first candidate ROP) (block 406). In some implementations, the initial ROP (or the first candidate ROP) may be selected based on a last known ROP or a predetermined ROP. In some implementations, the initial ROP may be derived based on a last known or last calculated porosity error. In another example, the last known ROP or the predetermined ROP may be a last calculated ROP. In another example, the predetermined ROP may be an ROP that is selected as a starting point, such as an ROP of zero or an ROP having a low value, or a random ROP value that is selected as a starting point.

In some implementations, the first NMR porosity data and the first neutron porosity data may be depth aligned based on the selected initial ROP (or the first candidate ROP) (block 408). For example, since timing information is known for the NMR and neutron measurements, and the distance between the NMR tool 120 and the neutron tool 130 is known, the first NMR porosity data and the first neutron porosity data may be depth aligned based on the selected initial ROP. As described above, the selected initial ROP may be a received surface ROP, a predetermined or last known ROP, etc.

In some implementations, the downhole device may determine a corrected NMR porosity data using the selected initial ROP (or the first candidate ROP) and in motion inclusive inversion or motion correction algorithms (block 410). For example, the first NMR porosity data may be corrected using the initial ROP and in motion inclusive inversion or motion correction algorithms. In some implementations, the downhole device may determine a first porosity error based on the corrected NMR porosity data and the first neutron porosity data (block 412). In some implementations, the downhole device may derive a first porosity error from the difference between the corrected NMR porosity data and the first neutron porosity data. For example, the first porosity error (which may also be referred to as a porosity delta or porosity difference) may be determined by the absolute value of the difference between the corrected NMR porosity data and the first neutron porosity data.

In some implementations, the downhole device may determine whether the first porosity error is minimized within a specified error tolerance by the corrected NMR porosity data and the first neutron porosity data (block 414). For example, the first porosity error is minimized within the specified error tolerance when the first porosity error is less than a porosity error threshold. In one example, the porosity error threshold may be a value close to zero or approximately zero. In another example, the first porosity error is minimized within the specified error tolerance when the first porosity error is less than other porosity errors derived from other NMR and neutron measurements. In some instances, the first porosity error may be minimized or be approximately zero when measurements are taken in sections of the subsurface formation that are homogenous and/or when the measurements are taken in horizontal sections of the wellbore (i.e., when the depth associated with the NMR and neutron tools is approximately the same). Since the NMR tool 120 and the neutron tool 130 are located in different parts of the work string 115, the depth that the measurements are taken at any particular time are taken at different depths, unless the section of the subsurface formation is a horizontal section. Therefore, when measurements are taken in non-horizontal sections of the wellbore or when the subsurface formation is heterogenous, the NMR and neutron porosity data will likely be different and thus the resulting porosity error will not be minimized. In some implementations, to account for the different depths and heterogenous subsurface formation sections, the NMR and neutron porosity data is depth aligned, as described above in block 408. It is noted, however, that in some implementations the NMR and neutron porosity data may not be depth aligned in the operations described in FIG. 4. For example, the NMR and neutron measurements may be assumed to be depth aligned (e.g., measurements taken in a horizontal section of the well), or the NMR tool 120 and the neutron tool 130 may be located at approximately the same location/depth and any variations may be assumed to be negligible.

In some implementations, if the corrected NMR porosity data and the first neutron porosity data minimize the first porosity error within the error tolerance, the downhole device may select or designate the initial ROP (or the first candidate ROP) as the downhole ROP (block 416). In some implementations, the NMR tool 120 may continue performing NMR measurements and the neutron tool 130 may continue performing neutron measurements. The downhole device may continue to perform the operations described in FIG. 4 continuously or periodically to update the downhole ROP to continue to use an accurate ROP and transmitting an accurate ROP to other downhole devices to perform downhole well operations.

In some implementations, if the corrected NMR porosity data and the first neutron porosity data do not minimize the first porosity error within the error tolerance, the downhole device may determine whether the ROP selection set is exhausted (block 418) or, if the ROP is calculated from the porosity error, if the convergence is not achieved. In some implementations, the ROP selection set may be another known or predetermined ROP or previously calculated ROP (e.g., based on a porosity error) that can be used to try to minimize the porosity error. In some implementations, if the initial ROP was selected as a low ROP value or an ROP of zero, the ROP selection set may be a sequence of low ROP values, and the downhole device may select a next low ROP value in the sequence of low ROP values. In some implementations, if the ROP selection set has been exhausted or the convergence is not achieved, the process loops back to block 402, and the operations of FIG. 4 restart with new NMR and neutron measurements. In some implementations, if the ROP selection set has not been exhausted or the convergence has been achieved, the process loops back to determine whether another surface ROP was received in order to select a second candidate ROP (block 404). The operations of blocks 405-416 may be repeated using the second candidate ROP (and any additional candidates ROP if the process continues to loop, e.g., third candidate ROP, fourth candidate ROP, etc.). In some implementations, if another surface ROP is received, another ROP value is selected as the second candidate ROP based on a received surface ROP (block 405). In some implementations, the second candidate ROP may be determined based on the first porosity error and the NMR and neutron porosity data may be depth aligned based on the second candidate ROP (block 408). A second corrected NMR porosity data may be determined based on the second candidate ROP and in motion inclusive inversion or motion correction algorithms (block 410). For example, the first NMR porosity data may be corrected using the second candidate ROP and in motion inclusive inversion or motion correction algorithms. In some implementations, the downhole device may determine a second porosity error based on the second corrected NMR porosity data and the first neutron porosity data (block 412). The downhole device may derive a second porosity error from the difference between the second corrected NMR porosity data and the first neutron porosity data. In some implementations, the downhole device may determine whether the second porosity error is minimized within the specified error tolerance by the second corrected NMR porosity data and the first neutron porosity data (block 414). In some implementations, if the second corrected NMR porosity data and the first neutron porosity data minimize the second porosity error within the error tolerance, the downhole device may select the second candidate ROP as the downhole ROP (block 416). Otherwise, the process loops back and performs the operation of block 418, as described above.

In one non-limiting example, as described in FIG. 2, the porosity error or Delta_PU can be determined as shown in Equation 1.1 above. The determined downhole ROP, which may also be referred as the true ROP, ROPₜᵣᵤₑ, of the NMR tool 120 is the v_{q} (i.e., the NMR tool ROP) that has the minimum Delta_PU_{q}. ROPₜᵣᵤₑ can be used to calculate the true spectrum Xₜᵣᵤₑ as shown in Equation 1.2 above. After verifying the determined downhole ROP is the true downhole ROP, the downhole ROP can be used to determine a true spectrum (or a more accurate spectrum) associated with the subsurface formation, which may be used to determine one or more properties of the subsurface formation. For example, the true spectrum (e.g., Xₜᵣᵤₑ) can be interpreted to determine porosity, free fluid porosity, macro porosity, micro porosity, differential oil/gas/water, diffusivity, hydrocarbon producibility, or permeability of formation, among others. The properties of the subsurface formation can be used for well site planning, hydrocarbon recovery operations, and other well operations. In some implementations, well operations associated with the subsurface formation (e.g., such as drilling the well or hydrocarbon recovery) can be determined or modified, or parameters or features or attributes of the well operation can be determined or modified, based on the determined properties of the subsurface formation.

In some implementations, the determined downhole ROP can be communicated to one or more downhole well devices and tools that can utilize the downhole ROP. For example, the determined downhole ROP can be communicated to an autonomous steering device that controls autonomous steering for drilling operations or for other well operations.

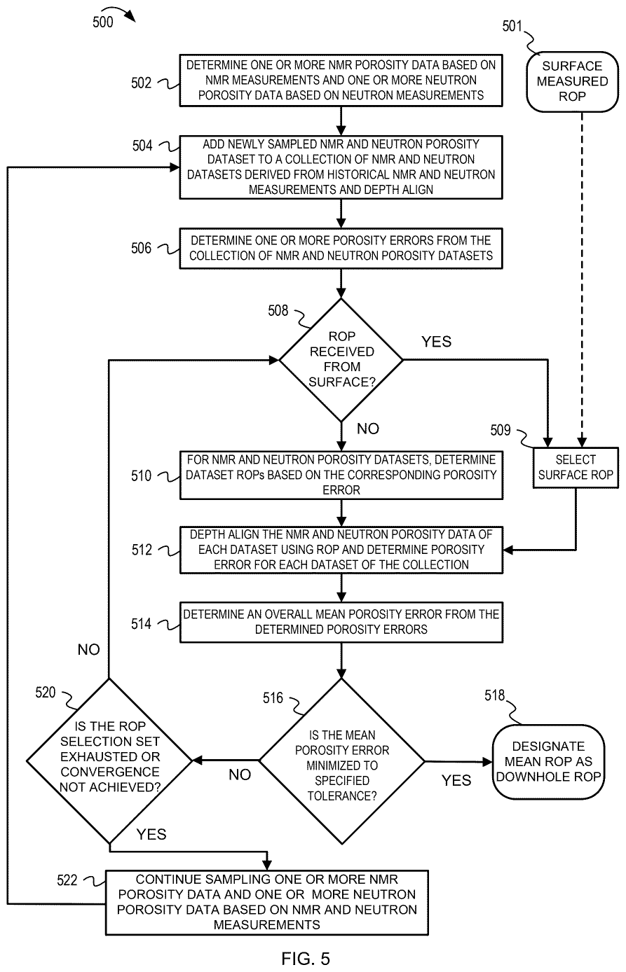

FIG. 5 depicts a workflow of example operations for determining a downhole ROP based on a received surface ROP or candidate ROPs determined from a collection of downhole NMR and other porosity tool measurements, such as neutron tool measurements, according to some implementations. In some implementations, a downhole device of the well system 100 may obtain a surface ROP from the surface equipment of the well system (block 501). For example, the surface equipment may calculate a surface ROP based on the movement of the work string 115 downhole during LWD or MWD or while performing other well operations. As described above in FIGS. 2-4, the downhole device may include at least one of the downhole computing device 175, the NMR tool 120, and the neutron tool 130. The NMR tool 120 and the neutron tool 130 may perform measurements during the well operations. In some implementations, the downhole device may determine NMR porosity data based on multiple sets of NMR measurements, and neutron porosity data based on multiple sets of neutron measurements (block 502). For example, for NMR, the NMR measurements may include obtaining NMR echo data (e.g., NMR echo train data), and performing an inversion operation on the NMR echo data to determine the properties of the subsurface formation, including porosity. The neutron measurements may also be processed to determine properties of the subsurface formation, such as porosity. It is noted that, in some implementations, other types of porosity measurement tools or porosity tools may be used in the well system 100 in addition to, or instead of, the neutron tool 130 to measure, derive, or infer the porosity of the subsurface formation.

In some implementations, the newly sampled NMR porosity and neutron porosity dataset is added to a collection of NMR porosity and neutron porosity datasets derived from historical NMR and neutron measurements and the collection of datasets is depth aligned (block 504). The historical NMR and neutron measurements may be the latest measurements that have been performed within a specified or predefined time period. For example, the historical NMR and neutron measurements may be the latest measurement performed within the last specified number of days (e.g., two days or four days) or within the last specified number of weeks (e.g., one week or two weeks). It is noted, however, that the historical NMR and neutron measurements may be obtained from any time period as needed. In some implementations, the downhole device may depth align the collection of NMR and neutron porosity datasets based on a selected initial ROP. In some implementations, during the initial phase, the selected ROP may be referred to as an initial ROP or a first candidate ROP. In some implementations, the initial ROP (or the first candidate ROP) may be selected based on a last known ROP or a predetermined ROP. In some implementations, the initial ROP may be derived based on a last known or last calculated porosity error. In one example, the last known ROP or the predetermined ROP may be a last calculated ROP. In another example, the predetermined ROP may be an ROP that is selected as a starting point, such as an ROP of zero or an ROP having a low value, or a random ROP value that is selected as a starting point. In some implementations, since timing information is known for the NMR and neutron measurements, and the distance between the NMR tool 120 and the neutron tool 130 is known, the collection of NMR and neutron porosity datasets may be depth aligned based on the initial ROP or the first candidate ROP.

In some implementations, one or more porosity errors may be determined from the collection of NMR and neutron porosity datasets (block 506). For example, a porosity error may be derived from each NMR and neutron porosity datasets. In some implementations, each porosity error may be derived from the difference between the NMR porosity data and the neutron porosity data from each dataset. For example, the porosity error may be determined by the absolute value of the difference between the NMR porosity data and the neutron porosity data. In some implementations, the downhole device may determine whether a surface ROP was received (block 508). In some implementations, if the downhole device receives the surface ROP, the downhole device select the surface ROP as the second candidate ROP (block 509). In some implementations, if a surface ROP is not received, for the NMR and neutron porosity datasets, dataset ROPs (or second candidate ROPs) may be determined based on the porosity error associated with the corresponding dataset (block 510). In some implementations, the NMR and neutron porosity data of each dataset may be depth aligned using the corresponding dataset ROP or the surface ROP, and multiple porosity errors are determined from the collection of the depth aligned NMR and neutron porosity datasets (block 512). The depth aligned NMR and neutron porosity datasets may also be referred to as the ROP corrected NMR and neutron porosity datasets. For example, each depth aligned NMR and neutron porosity dataset may be used to calculate a porosity error. In some implementations, an overall mean porosity error may be determined from the multiple porosity errors that are derived from the collection of the depth aligned NMR and neutron porosity datasets (block 514). The overall mean porosity error may be calculated using one or more techniques. For example, the overall mean porosity error may be calculated using at least one of the mean, log mean, or the geometric mean, among others, of the multiple porosity errors that are derived from the collection. The first iteration of the mean porosity error may be referred to as a first candidate mean porosity error or the initial mean porosity error. As described above, in some implementations, to account for the different depths and heterogenous subsurface formation sections, the NMR and neutron porosity datasets may be depth aligned as described above in blocks 504 and 512. It is noted, however, that in some implementations the NMR and neutron porosity data may not be depth aligned in the operations described in FIG. 5. For example, the NMR and neutron measurements may be assumed to be depth aligned (e.g., measurements taken in a horizontal section of the well), or the NMR tool 120 and the neutron tool 130 may be located at approximately the same location/depth (e.g., approximately the same location in the work string) and any variations may be assumed to be negligible.

In some implementations, the downhole device may determine whether the determined overall mean porosity error is minimized within a specified error tolerance (block 516). For example, the mean porosity error is minimized within the specified error tolerance when the mean porosity error is less than a porosity error threshold. In one example, the porosity error threshold may be a value close to zero or approximately zero. In some implementations, if the mean porosity error is minimized within the error tolerance, the downhole device may select or designate a mean ROP as the downhole ROP (block 518). The downhole ROP may also be referred to as the true downhole ROP. In some implementations, the mean ROP may be derived by calculating the mean of the different dataset ROPs that were determined in block 510. For example, the mean ROP may be calculated using at least one of the mean, log mean, or the geometric mean, among others, of the multiple dataset ROPs that are derived from the collection of datasets. The mean ROP may also be the surface ROP, if a surface ROP is received by the downhole device. The first iteration of the mean ROP may be referred to as the first candidate mean ROP or the initial mean ROP. In some implementations, the NMR tool 120 may continue performing NMR measurements and the neutron tool 130 may continue performing neutron measurements. The downhole device may continue to perform the operations described in FIG. 5 continuously or periodically to update the downhole ROP to continue to use an accurate ROP and continue to transmit an accurate ROP to other downhole devices to perform downhole well operations.

In some implementations, if the mean porosity error is not minimized within the error tolerance, the downhole device may determine whether the ROP selection set is exhausted (block 520) or, if the ROP is calculated from the porosity error, the convergence is not achieved. In some implementations, the ROP selection set may be additional dataset ROPs that may be derived from additional NMR and neutron measurements, or may be additional dataset ROPs that are derived from additional NMR and neutron measurements that were not included in the initial collection of datasets. In some implementations, if the ROP selection set has been exhausted or the convergence has not been achieved, the downhole device may continue sampling NMR porosity data based on NMR measurements and neutron porosity data based on neutron measurements (block 522), and then the process loops back to block 504, and the operations of FIG. 5 restart with new NMR and neutron porosity data. In some implementations, if the ROP selection set has not been exhausted or the convergence has been achieved, the downhole device determines whether another surface ROP has been received (block 508), and either selects the new surface ROP (block 509) or selects one or more additional ROP dataset ROPs from the ROP selection set for addition to the collection of datasets. Then, the operations of blocks 510-516 are repeated using an updated mean porosity error and mean ROP. During a second iteration (if there is a second iteration), the updated mean porosity error may be referred to as the second candidate mean porosity error and the updated mean ROP may be referred to as the second candidate mean ROP. During a third iteration (if there is a third iteration), the updated mean porosity error may be referred to as the third candidate mean porosity error and the updated mean ROP may be referred to as the third candidate mean ROP, and so on for additional iterations.

In one non-limiting example, as described in FIG. 2, the porosity error or Delta_PU can be determined as shown in Equation 1.1 above. The determined downhole ROP, which may also be referred as the true ROP, ROPₜᵣᵤₑ, of the NMR tool 120 is the v_{q} (i.e., the NMR tool ROP) that has the minimum Delta_PU_{q}. ROPₜᵣᵤₑ can be used to calculate the true spectrum Xₜᵣᵤₑ as shown in Equation 1.2 above. After verifying the determined downhole ROP is the true downhole ROP, the downhole ROP can be used to determine a true spectrum (or a more accurate spectrum) associated with the subsurface formation, which may be used to determine one or more properties of the subsurface formation. For example, the true spectrum (e.g., Xₜᵣᵤₑ) can be interpreted to determine porosity, free fluid porosity, macro porosity, micro porosity, differential oil/gas/water, diffusivity, hydrocarbon producibility, or permeability of formation, among others. The properties of the subsurface formation can be used for well site planning, hydrocarbon recovery operations, and other well operations. In some implementations, well operations associated with the subsurface formation (e.g., such as drilling the well or hydrocarbon recovery) can be determined or modified, or parameters or features or attributes of the well operation can be determined or modified, based on the determined properties of the subsurface formation.

In some implementations, the determined downhole ROP can be communicated to one or more downhole well devices and tools that can utilize the downhole ROP. For example, the determined downhole ROP can be communicated to an autonomous steering device that controls autonomous steering for drilling operations or for other well operations.

In some implementations, the well system 100 may use a learning machine (such as a machine learning model, a machine learning neural network, or other suitable particularized machine) to receive the inputs, perform the operations, and generate the outputs described in FIGS. 2-5. In some implementations, the operations described above in FIGS. 2-5 that use mathematical models may instead be performed by a learning machine (or some combination of mathematical models and a learning machine) to receive the input (e.g., acquire NMR and neutron measurements), process the NMR and neutron measurements as described in FIGS. 2-5, and generate an output (e.g., downhole ROP). In some implementations, the learning machine or the machine learning model may include computer code and/or a neural network and be implemented on a non-transitory computer readable medium, circuitry, and/or any other logic components configured to perform the operations described herein.

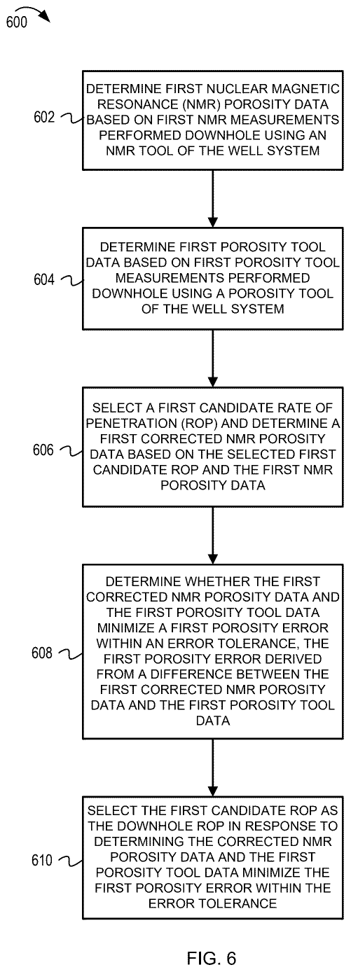

FIG. 6 is a flowchart 600 of example operations for downhole ROP determination in a well system, according to some implementations. In some implementations, first nuclear magnetic resonance (NMR) porosity data may be determined based on first NMR measurements performed downhole using an NMR tool of the well system (block 602). In some implementations, first porosity tool data may be determined based on first porosity tool measurements performed downhole using a porosity tool of the well system (block 604). In some implementations, a first candidate ROP may be selected and a first corrected NMR porosity data may be determined based on the selected first candidate ROP and the first NMR porosity data (block 606). In some implementations, it may be determined whether the first corrected NMR porosity data and the first porosity tool data minimize a first porosity error within an error tolerance. The first porosity error may be derived from the difference between the first NMR porosity data and the first porosity tool data (block 608). In some implementations, the first candidate ROP is selected as the downhole ROP in response to determining the corrected NMR porosity data and the first porosity tool data minimize the first porosity error within the error tolerance (block 610).

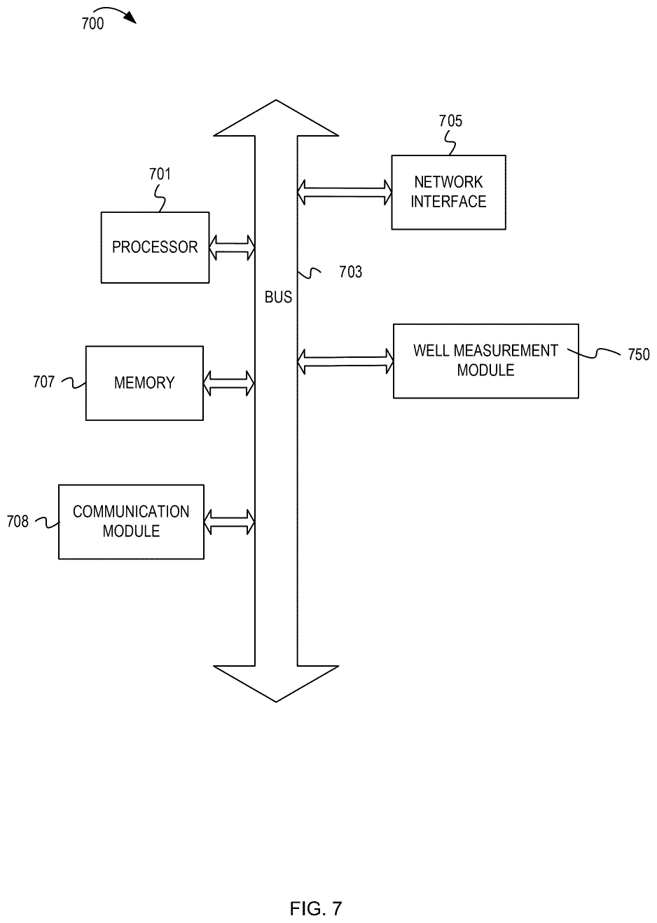

FIG. 7 depicts an example computer system of a well system for processing NMR and neutron measurements, according to some implementations. In some implementations, the computer system 700 may be an example of a computer system that may be used during the operation of the well system, such as the computer system 110 shown in FIG. 1. For example, the computer system 700 may be a standalone computer system (such as a workstation, laptop, or desktop), or may be partially or fully integrated into other surface equipment of the well system (e.g., control panel or truck). In some implementations, the computer system 700 may be implemented partially or fully in downhole components of the well system (e.g., within the NMR tool and/or work string and/or well tubing) or the computing functions of the computer system 700 may be distributed across both downhole components (e.g., NMR tool and/or work string) and surface equipment (e.g., workstation or other computer subsystem). The computer system 700 may include one or more processors 701 (possibly including multiple cores, multiple nodes, and/or implementing multi-threading, etc.). The computer system 700 may include memory 707. The memory 707 may be system memory or any type or implementation of machine or computer readable media having instructions that are executable by the one or more processors 701 to implement the operations described in FIGS. 1-6. The memory 707 may be system memory or any type or implementation of machine or computer readable and writable media having the ability to receive, process and/or store measurement data from well devices and tools (including those described in FIGS. 1-6). The computer system 700 also may include a bus 703 and a network interface 705. The computer system 700 also may include a communications module 708 that may control wired and wireless communications, such as communicating with downhole devices or tools and communicating with other surface equipment. The computer system 700 also may include at least a well measurement module 750 and a spin dynamic simulator 770, among other processing units or modules that are used during the operation of the well system and the well tools described herein (not shown for simplicity). The well measurement module 750 may control above ground and downhole equipment and tools to obtain measurement data, such as controlling an NMR tool that can take NMR measurements downhole and controlling a neutron tool that can take neutron measurements downhole, as described in FIGS. 1-6. The well measurement module 750 may perform the operations described above in FIGS. 1-6 for obtaining NMR and neutron measurements, determining NMR and neutron porosity data, determining a porosity error, and determining a downhole ROP. In some implementations, the well measurement module 750 (in conjunction with other control and processing units of the computer system 700) may utilize the NMR and neutron measurements and the downhole ROP for determining properties of the subsurface formation and performing and/or modifying well operations (or well parameters/attributes) based on the determined properties of the subsurface formation, as described above. It is noted that, in some implementations, the well measurement module 750 may obtain measurements from other types of porosity measurement tools or porosity tools in addition to, or instead of, the neutron tool to measure, derive, or infer the properties of the subsurface formation, such as the porosity of the subsurface formation. The functionality described herein may be implemented with an application-specific integrated circuit, in logic implemented in the processor(s) 701, in a co-processor on a peripheral device or card, etc. Further, implementations may include fewer or additional components not illustrated in FIG. 7. The processor(s) 701 and the network interface 705 may be coupled to the bus 703. Although illustrated as being coupled to the bus 703, the memory 707 may be coupled to the processor(s) 701.

NMR logging is possible because when an assembly of magnetic moments, such as those of hydrogen nuclei, are exposed to a static magnetic field they tend to align along the direction of the magnetic field, resulting in bulk magnetization. The rate at which equilibrium is established in such bulk magnetization upon provision of a static magnetic field is characterized by the parameter T1, referred to as the spin-lattice relaxation time. Another related NMR logging parameter is T2, referred to as the spin-spin relaxation time constant (also referred to as the transverse relaxation time), which is an expression of the relaxation due to nuclear spins dephasing. NMR logging has two main experiments in oil field downhole usage. The first experiment is to assess T1 buildup of magnetization, and the second experiment is to observe the decay of magnetization once it has been excited, in which the decay has a time constant of T2.

Measurement of T1 is indirect and is done by varying the polarization times after magnetization has, through some means, been nullified or inverted. For downhole observation, an NMR measurement technique, designed by Carr, Purcell, Meiboom, and Gill and, hence, referred to as CPMG, is used. It is considered a T2 measurement. As described previously, CPMG has an excitation pulse followed by several refocusing pulses to counter the magnetic gradients in downhole NMR systems. A T1 sequence is typically performed as: Nullification Pulse—WaitTime—Excitation Pulse—Refocusing pulses. In some cases, the T1 sequence has several different wait times. The number of refocusing pulses may be as few as 3 and as many as associated electronics are configured to handle (e.g., acquire and/or process).

The spin axes of the hydrogen nuclei in the earth formation are, in the aggregate, caused to be aligned with the magnetic field induced in the earth formation by a magnet. The NMR tool (e.g., such as the NMR tool 120 in FIG. 1) also includes an antenna positioned near the magnet and shaped so that a pulse of RF power conducted through the antenna induces a magnetic field in the earth formation orthogonal to the field induced by the magnet. A receiving antenna (which may be the same antenna as the one that generates the initial RF pulse) is electrically connected to a receiver, which detects and measures voltages induced in the receiving antenna by precessional motion of the spin axes of the nuclei.

An NMR measurement involves a plurality of pulses grouped into pulse sequences, most frequently of a type known as CMPG pulsed spin echo sequences. Each CPMG sequence consists of a 90-degree (i.e., π/2) pulse, which may be an excitation pulse, followed by several refocusing pulses, which may be 180-degree (i.e., π) rotation pulses. The 90-degree pulse rotates the proton spins into the transverse plane and the refocusing pulses generate a sequence of spin echoes by refocusing the transverse magnetization after each spin echo.

NMR well logging data are sensitive to motion of the NMR tool. In an example in which the NMR tool is used in a logging while drilling (LWD) or a measurement while drilling (MWD) context, a lateral motion (e.g., vibration) and rotational movement of drilling operations may cause distortion of the NMR well logging data and, in some cases, an inability to acquire a spin echo signal representing transversal NMR relaxation (i.e., T2 relaxation).

While rotational sensitivity may be reduced by designing the NMR tool to be essentially axially symmetrical, the longitudinal and lateral displacement due to NMR tool motion (e.g., vibration), such as while drilling, remains problematic for NMR data acquisition in a LWD or MWD context.

In some implementations, the NMR logging operations can be performed in connection with various types of downhole operations at various stages in the lifetime of a well system. Structural attributes and components of the surface equipment and NMR tool can be adapted for various types of NMR logging operations. For example, NMR logging may be performed during wireline logging operations (e.g., see FIG. 8), during drilling operations (e.g., see FIG. 9), or in other contexts. Accordingly, the surface equipment and the NMR tool may include, or may operate in connection with drilling equipment, wireline logging equipment, or other equipment for other types of operations. As another example, NMR logging may be performed in an offshore or subsea environment. Accordingly, the surface equipment may be arranged on a drill ship or other offshore drilling vessel, and the NMR tool operates in connection with offshore drilling equipment, offshore wireline logging equipment, or other equipment for use with offshore operations.

FIG. 8 shows an example well system 800 that includes the NMR tool 120 in a wireline logging environment, according to some implementations. The NMR tool 120 may be an example of the NMR tool 120 described in FIGS. 1-7. The well system 800 may also include a neutron tool (not shown), such as the neutron tool 130 described in FIGS. 1-7. In some implementations, the NMR tool and the neutron tool can perform NMR and neutron measurements, process the measurements downhole, and determine a downhole ROP, as described above in FIGS. 1-7. It is noted that, in some implementations, other types of porosity measurement tools or porosity tools may be used in the well system 800 in addition to, or instead of, the neutron tool 130.

In some example wireline logging operations, the surface equipment 880 may include a platform above the surface equipped with a derrick 881 that supports a wireline cable 882 that extends into the wellbore 802 through the wellhead 805. Wireline logging operations can be performed, for example, after a drill string is removed from the wellbore 802, to allow the NMR tool 120 to be lowered by wireline or logging cable into the wellbore 802.

FIG. 9 shows an example well system 900 that includes the NMR tool 120 in a drilling environment, according to some implementations. For example, the drilling environment may include performing logging while drilling (LWD) operations or a measurement while drilling (MWD) operations. The NMR tool 120 may be an example of the NMR tool 120 shown in FIG. 1. The well system 900 may also include a neutron tool (not shown), such as the neutron tool 130 described in FIGS. 1-7. In some implementations, the NMR tool and the neutron tool can perform NMR and neutron measurements, process the measurements downhole, and determine a downhole ROP, as described above in FIGS. 1-7. The downhole ROP can be used for drilling operations, such as autonomous steering during drilling operations.

Drilling is commonly carried out using a string of drill pipes connected together to form a drill string 940 that is lowered through a rotary table into the wellbore 802. In some cases, a drilling rig 942 at the surface 901 supports the drill string 940, as the drill string 940 is operated to drill a wellbore penetrating the subsurface formation 850. The drill string 940 may include, for example, a kelly, drill pipe, a bottomhole assembly, and other components. The bottomhole assembly on the drill string may include drill collars, drill bits, the NMR tool 120, and other components, including additional logging tools. The additional logging tools may include MWD tools, LWD tools, and others.

In some implementations, the NMR tool 120 is configured to obtain NMR measurements from the subsurface formation 850. As shown, for example, in FIG. 8, the NMR tool 120 can be suspended in the wellbore 802 by a coiled tubing, wireline cable, or another structure that connects the tool to a surface control unit or other components of the surface equipment 880. In some example implementations, the NMR tool 120 is lowered to the bottom of a region of interest and subsequently pulled upward (e.g., at a substantially constant speed) through the region of interest. As shown, for example, in FIG. 9, the NMR tool 120 can be deployed in the wellbore 802 on jointed drill pipe, hard wired drill pipe, or other deployment hardware. In some example implementations, the NMR tool 120 collects data (e.g., measurement data) during drilling operations as it moves downward through the region of interest. In some example implementations, the NMR tool 120 collects data while the drill string 940 is moving, for example, while it is being tripped in or tripped out of the wellbore 802.

In some implementations, the NMR tool 120 collects data at discrete logging points in the wellbore 802. For example, the NMR tool 120 can move upward or downward incrementally to each logging point at a series of depths in the wellbore 802. At each logging point, instruments in the NMR tool 120 perform measurements on the subsurface formations 850. The measurement data can be communicated to the computer system 110 for storage, processing, and analysis. Such data may be gathered and analyzed during drilling operations (e.g., during LWD/MWD operations), during wireline logging operations, or during other types of activities. The computer system 110 shown in FIGS. 8 and 9 may be configured to receive and analyze the measurement data from the NMR tool 120 to detect properties of the subsurface formation 850, as previously described above in FIG. 1.

In some implementations, the NMR tool 120 obtains NMR signals by polarizing nuclear spins in the subsurface formation 850 and pulsing the nuclei with a radio frequency (RF) magnetic field. Various pulse sequences (i.e., series of radio frequency pulses, delays, and other operations) can be used to obtain NMR signals, including the CPMG sequence (in which the spins are first tipped using an excitation (or tipping) pulse followed by a series of refocusing pulses), the Optimized Refocusing Pulse Sequence (ORPS) (in which the refocusing pulses are less than 180°), a saturation recovery pulse sequence, and other pulse sequences. The NMR tool 120 collects measurements relating to spin relaxation time (e.g., T1, T2) distributions as a function of depth or position in the borehole. The NMR tool 120 has a magnet, antenna, and supporting electronics. The permanent magnet in the tool causes the nuclear spins to build up into a cohesive magnetization. The T2 is measured through the decay of excited magnetization while T1 is measured by the buildup of magnetization.

The computer system 110 is configured to process (e.g., invert, transform, etc.) the acquired spin echo signals (or other NMR data) to obtain an NMR signal, such as a relaxation-time distribution (e.g., a distribution of transverse relaxation times T2, or a distribution of longitudinal relaxation times T1, or both). For example, the acquired spin echo signals are integrated using acquisition windows having different durations to generate the different NMR signals. The relaxation-time distribution can be used to determine various physical properties of the formation by solving one or more inverse problems. In some cases, relaxation-time distributions are acquired for multiple logging points and used by the computer system 110 to train a model of the subsurface formation 850. In some cases, relaxation-time distributions are acquired for multiple logging points and used by the computer system 110 to predict properties of the subsurface formation 850. The relaxation data may also be referred to as NMR echo train data.

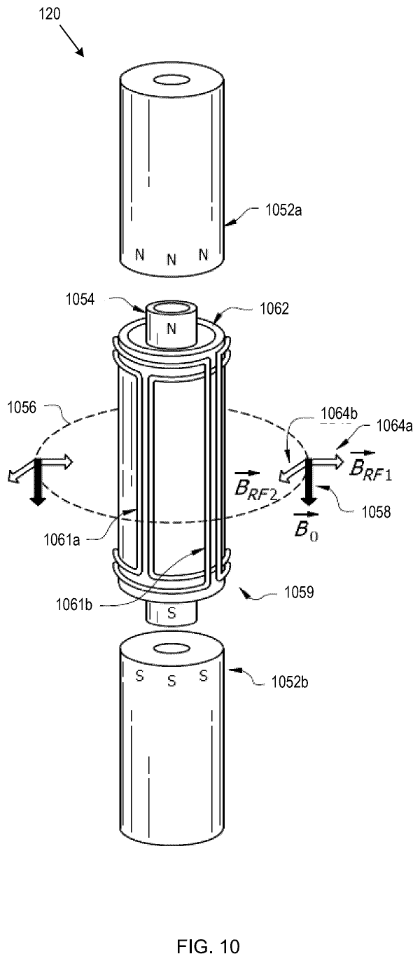

FIG. 10 is a diagram of an example NMR magnet and antenna(s) configuration of an NMR tool 120, according to some implementations. The example NMR tool 120 includes a magnet assembly that generates a static magnetic field to produce polarization, and an antenna assembly that generates a radio frequency (RF) magnetic field to excite nuclei and acquires NMR signals from the surrounding formation. In the non-limiting example shown in FIG. 10, the magnet assembly that includes the end piece magnets 1052a, 1052b and a central magnet 1054 generates the static magnetic field in the volume of investigation 1056. The poles of the central magnet 1054 (e.g., north (N) and south(S)) face the like poles of the proximal end piece magnets 1052a, 1052b. The central magnet 1054 is useful to shape and strengthen the static magnetic field in the volume of investigation 1056. In this example, the volume of investigation 1056 is approximately a cylindrical shell. In the volume of investigation 1056, the direction of the static magnetic field (shown as the solid black arrow 1058) is parallel to the longitudinal axis of the wellbore. In some examples, a magnet configuration with a bigger central magnet can be used to create a double pole strength and therefore increase the strength of the magnetic field (e.g., up to 100-150 Gauss or higher in some instances).

In the non-limiting example shown in FIG. 10, the antenna assembly 1059 includes two mutually orthogonal transversal dipole antennas 1061a, 1061b. In some instances, the NMR tool 120 can be implemented with a single transversal-dipole antenna. For example, one of the orthogonal transversal-dipole antennas 1061a, 1061b may be omitted from the antenna assembly 1059. The example orthogonal transversal-dipole antenna 1061a, 1061b shown in FIG. 10 are placed on an outer surface of a soft magnetic core 1062, which is useful for RF magnetic flux concentration. The antenna assembly 1059 generates two orthogonal RF magnetic fields 1064a (e.g., produced by the antenna 1061a) and 1064b (e.g., produced by the antenna 1061b). The two RF magnetic fields 1064a, 1064b have a phase shift of 90°. Accordingly, the RF magnetic fields 1064a, 1064b generate a circular polarized RF magnetic field to excite NMR in the surrounding formation more efficiently. It is also possible to only transmit with one antenna, even if a second antenna is included in the assembly. For example, the second antenna could be used only to receive NMR signals in this configuration. The same two orthogonal transversal-dipole antennas 1061a, 1061b are used to receive NMR signals from the surrounding formation. The received NMR signals are from induced currents from the NMR magnetization. The signals in the orthogonal transversal-dipole antennas 1061a, 1061b, may then be processed (e.g., by the computer system 110 of FIGS. 1 and 9-11) together in order to increase a signal-to-noise ratio (SNR) of the acquired NMR data.

In some implementations, the antenna assembly 1059 additionally or alternatively includes an integrated coil set that performs the operations of the two orthogonal transversal-dipole antennas 1061a, 1061b. For example, the integrated coil may be useful (e.g., instead of the two orthogonal transversal-dipole antennas 1061a, 1061b) to produce circular polarization and perform quadrature coil detection. Examples of integrated coil sets that can be adapted to perform such operations include multi-coil or complex single-coil arrangements, such as, for example, birdcage coils used for high-field magnetic resonance imaging (MRI). It is noted that the specific geometry and/or configuration of the NMR tool 120 is not necessarily limited to that shown in FIG. 10, and in other implementations, the NMR tool 120 may have different geometry and/or configurations.

Although some example well systems are described in FIGS. 1-10, it is noted, however, that the techniques and operations for performing NMR and neutron measurements, processing the measurements and determining a downhole ROP described in FIGS. 1-10 can be used in any type of well system in the oil and gas industry.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

None of the implementations described herein may be performed exclusively in the human mind nor exclusively using pencil and paper. None of the implementations described herein may be performed without computerized components such as those described herein. Some implementations may perform additional operations, fewer operations, operations in parallel or in a different order, and some operations differently.

While the aspects of the disclosure are described with reference to various implementations and exploitations, it will be understood that these aspects are illustrative and that the scope of the claims is not limited to them. In general, techniques for performing NMR and neutron measurements, processing the measurements and determining a downhole ROP as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

Furthermore, unless otherwise specified, use of the terms “up,” “upper,” “upward,” “uphole,” “upstream,” or other like terms shall be construed as generally away from the bottom, terminal end of a well; likewise, use of the terms “down,” “lower,” “downward,” “downhole,” or other like terms shall be construed as generally toward the bottom, terminal end of the well, regardless of the wellbore orientation. Use of any one or more of the foregoing terms shall not be construed as denoting positions along a perfectly vertical axis. In some instances, a part near the end of the well can be horizontal or even slightly directed upwards. Unless otherwise specified, use of the term “subterranean formation” shall be construed as encompassing both areas below exposed earth and areas below earth covered by water such as ocean or fresh water.

### EXAMPLE EMBODIMENTS

Example Embodiments can include the following:

Embodiment #1: A method for downhole rate of penetration (ROP) determination in a well system, comprising: determining first nuclear magnetic resonance (NMR) porosity data based on first NMR measurements performed downhole using an NMR tool of the well system; determining first porosity tool data based on first porosity tool measurements performed downhole using a porosity tool of the well system; selecting a first candidate ROP and determining a first corrected NMR porosity data based on the selected first candidate ROP and the first NMR porosity data; determining whether the first corrected NMR porosity data and the first porosity tool data minimize a first porosity error within an error tolerance, the first porosity error derived from a difference between the first corrected NMR porosity data and the first porosity tool data; and selecting the first candidate ROP as a downhole ROP in response to determining the corrected NMR porosity data and the first porosity tool data minimize the first porosity error within the error tolerance

Embodiment #2: The method of Embodiment #1, further comprising: depth aligning the first NMR porosity data and the first porosity tool data based on the selected first candidate ROP prior to determining the first corrected NMR porosity data.

Embodiment #3: The method of Embodiment #1, further comprising: in response to determining the first corrected NMR porosity data and the first porosity tool data do not minimize the first porosity error within the error tolerance, selecting a second candidate ROP based on the first porosity error; depth aligning the first NMR porosity data and the first porosity tool data based on the selected second candidate ROP; determining a second corrected NMR porosity data based on the selected second candidate ROP and the first NMR porosity data; determining whether the second corrected NMR porosity data and the first porosity tool data minimize a second porosity error within the error tolerance, the second porosity error derived from a difference between the second corrected NMR porosity data and the first porosity tool data; and selecting the second candidate ROP as the downhole ROP in response to determining the second corrected NMR porosity data and the first porosity tool data minimize the second porosity error within the error tolerance.

Embodiment #4: The method of Embodiment #3, wherein the first corrected NMR porosity data and the second corrected NMR porosity data are further determined based on motion inclusive inversion or motion correction algorithms.

Embodiment #5: The method of Embodiment #1, further comprising: determining whether a surface ROP is obtained from surface equipment of the well system; if the surface ROP is obtained, selecting the surface ROP as the first candidate ROP; and if the surface ROP is not obtained, determining the first candidate ROP based on a last known ROP, a predetermined ROP, or a last derived porosity error.

Embodiment #6: The method of Embodiment #1, wherein the first NMR porosity data and the first porosity tool data include a plurality of NMR porosity datasets and a plurality of porosity tool datasets, further comprising: determining a plurality of porosity errors from the plurality of NMR porosity datasets and the plurality of porosity tool datasets; determining a plurality of dataset ROPs based on the plurality of porosity errors, determining a mean ROP based on the plurality of dataset ROPs, and designating the mean ROP as a second candidate ROP; determining a mean porosity error based on the plurality of porosity errors; determining whether the mean porosity error is minimized within the error tolerance; and selecting the second candidate ROP as the downhole ROP in response to determining the mean porosity error is minimized within the error tolerance.

Embodiment #7: The method of Embodiment #6, further comprising: depth aligning the plurality of NMR porosity datasets and the plurality of porosity tool datasets based on a corresponding dataset ROP; and determining the plurality of porosity errors from the depth aligned plurality of NMR porosity datasets and the depth aligned plurality of porosity tool datasets.

Embodiment #8: The method of Embodiment #6, further comprising: determining whether a surface ROP is obtained from surface equipment of the well system; if the surface ROP is obtained, selecting the surface ROP as the second candidate ROP; and if the surface ROP is not obtained, determining the mean ROP based on the plurality of dataset ROPs, and designating the mean ROP as the second candidate ROP.

Embodiment #9: The method of Embodiment #1, wherein determining that the first NMR porosity data and the first porosity tool data minimize the first porosity error within the error tolerance includes at least one of: determining that the first porosity error is less than other porosity errors derived from other NMR and porosity tool data associated with other NMR and neutron measurements; or determining that the first porosity error is less than a porosity error threshold.

Embodiment #10: The method of Embodiment #1, further comprising: modifying at least one of a well operation or a well operation attribute based on the selected downhole ROP.

Embodiment #11: The method of Embodiment #10, wherein the well operation includes at least one of an NMR well operation or an autonomous steering drilling operation; and the well operation attribute includes at least one of an NMR well operation attribute or an autonomous steering drilling operation attribute.

Embodiment #12: The method of Embodiment #1, further comprising: after downhole determination and selection of the downhole ROP, communicating the selected downhole ROP to one or more downhole well devices.

Embodiment #13: The method of Embodiment #1, wherein determining the first porosity tool data based on the first porosity tool measurements performed downhole using the porosity tool of the well system includes determining first neutron porosity data based on first neutron measurements performed downhole using a neutron tool of the well system.

Embodiment #14: A well system comprising: one or more processors; and a computer-readable storage medium having instructions stored thereon that are executable by the one or more processors to cause the well system to: determine first nuclear magnetic resonance (NMR) porosity data based on first NMR measurements performed downhole using an NMR tool of the well system; determine first porosity tool data based on first porosity tool measurements performed downhole using a porosity tool of the well system; select a first candidate ROP and determining a first corrected NMR porosity data based on the selected first candidate ROP and the first NMR porosity data; determine whether the first corrected NMR porosity data and the first porosity tool data minimize a first porosity error within an error tolerance, the first porosity error derived from a difference between the first corrected NMR porosity data and the first porosity tool data; and select the first candidate ROP as a downhole ROP in response to determining the corrected NMR porosity data and the first porosity tool data minimize the first porosity error within the error tolerance.

Embodiment #15: The well system of Embodiment #14, further comprising instructions that are executable by the one or more processors to cause the well system to: depth align the first NMR porosity data and the first porosity tool data based on the selected first candidate ROP prior to determining the first corrected NMR porosity data.

Embodiment #16: The well system of Embodiment #14, further comprising instructions that are executable by the one or more processors to cause the well system to: in response to a determination that the first corrected NMR porosity data and the first porosity tool data do not minimize the first porosity error within the error tolerance, select a second candidate ROP based on the first porosity error; depth align the first NMR porosity data and the first porosity tool data based on the selected second candidate ROP; determine a second corrected NMR porosity data based on the selected second candidate ROP and the first NMR porosity data; determine whether the second corrected NMR porosity data and the first porosity tool data minimize a second porosity error within the error tolerance, the second porosity error derived from a difference between the second corrected NMR porosity data and the first porosity tool data; and select the second candidate ROP as the downhole ROP in response to determining the second corrected NMR porosity data and the first porosity tool data minimize the second porosity error within the error tolerance.

Embodiment #17: The well system of Embodiment #14, further comprising instructions that are executable by the one or more processors to cause the well system to: determine whether a surface ROP is obtained from surface equipment of the well system; if the surface ROP is obtained, select the surface ROP as the first candidate ROP; and if the surface ROP is not obtained, determine the first candidate ROP based on a last known ROP, a predetermined ROP, or a last derived porosity error.

Embodiment #18: The well system of Embodiment #14, wherein the first NMR porosity data and the first porosity tool data include a plurality of NMR porosity datasets and a plurality of porosity tool datasets, further comprising instructions that are executable by the one or more processors to cause the well system to: determine a plurality of porosity errors from the plurality of NMR porosity datasets and the plurality of porosity tool datasets; determine a plurality of dataset ROPs based on the plurality of porosity errors, determining a mean ROP based on the plurality of dataset ROPs, and designating the mean ROP as a second candidate ROP; determine a mean porosity error based on the plurality of porosity errors; determine whether the mean porosity error is minimized within the error tolerance; and select the second candidate ROP as the downhole ROP in response to determining the mean porosity error is minimized within the error tolerance.

Embodiment #19: A non-transitory computer-readable storage medium having instructions stored thereon that are executable by one or more processors of a well system, the instructions comprising: instructions for determining first nuclear magnetic resonance (NMR) porosity data based on first NMR measurements performed downhole using an NMR tool of the well system; instructions for determining first porosity tool data based on first porosity tool measurements performed downhole using a porosity tool of the well system; instructions for selecting a first candidate ROP and determining a first corrected NMR porosity data based on the selected first candidate ROP and the first NMR porosity data; instructions for determining whether the first corrected NMR porosity data and the first porosity tool data minimize a first porosity error within an error tolerance, the first porosity error derived from a difference between the first corrected NMR porosity data and the first porosity tool data; and instructions for selecting the first candidate ROP as a downhole ROP in response to determining the corrected NMR porosity data and the first porosity tool data minimize the first porosity error within the error tolerance.

Embodiment #20: The non-transitory computer-readable storage medium of Embodiment #19, wherein the instructions further comprise: instructions for depth aligning the first NMR porosity data and the first porosity tool data based on the selected first candidate ROP prior to determining the first corrected NMR porosity data.

Embodiment #21: The non-transitory computer-readable storage medium of Embodiment #19, wherein the instructions further comprise: instructions for determining whether a surface ROP is obtained from surface equipment of the well system; if the surface ROP is obtained, instructions for selecting the surface ROP as the first candidate ROP; and if the surface ROP is not obtained, instructions for determining the first candidate ROP based on a last known ROP, a predetermined ROP, or a last derived porosity error.

What is claimed is:

1. A method for downhole rate of penetration (ROP) determination in a well system, comprising:
determining first nuclear magnetic resonance (NMR) porosity data based on first NMR measurements performed downhole using an NMR tool of the well system;
determining first porosity tool data based on first porosity tool measurements performed downhole using a porosity tool of the well system;
selecting a first candidate ROP and determining a first corrected NMR porosity data based on the selected first candidate ROP and the first NMR porosity data;
determining whether the first corrected NMR porosity data and the first porosity tool data minimize a first porosity error within an error tolerance, the first porosity error derived from a difference between the first corrected NMR porosity data and the first porosity tool data; and
selecting the first candidate ROP as a downhole ROP in response to determining the corrected NMR porosity data and the first porosity tool data minimize the first porosity error within the error tolerance.

2. The method of claim 1, further comprising:
depth aligning the first NMR porosity data and the first porosity tool data based on the selected first candidate ROP prior to determining the first corrected NMR porosity data.

3. The method of claim 1, further comprising:
in response to determining the first corrected NMR porosity data and the first porosity tool data do not minimize the first porosity error within the error tolerance, selecting a second candidate ROP based on the first porosity error;
depth aligning the first NMR porosity data and the first porosity tool data based on the selected second candidate ROP;
determining a second corrected NMR porosity data based on the selected second candidate ROP and the first NMR porosity data;
determining whether the second corrected NMR porosity data and the first porosity tool data minimize a second porosity error within the error tolerance, the second porosity error derived from a difference between the second corrected NMR porosity data and the first porosity tool data; and
selecting the second candidate ROP as the downhole ROP in response to determining the second corrected NMR porosity data and the first porosity tool data minimize the second porosity error within the error tolerance.

4. The method of claim 3, wherein:
the first corrected NMR porosity data and the second corrected NMR porosity data are further determined based on motion inclusive inversion or motion correction algorithms.

5. The method of claim 1, further comprising:
determining whether a surface ROP is obtained from surface equipment of the well system;
if the surface ROP is obtained, selecting the surface ROP as the first candidate ROP; and
if the surface ROP is not obtained, determining the first candidate ROP based on a last known ROP, a predetermined ROP, or a last derived porosity error.

6. The method of claim 1, wherein the first NMR porosity data and the first porosity tool data include a plurality of NMR porosity datasets and a plurality of porosity tool datasets, further comprising:
determining a plurality of porosity errors from the plurality of NMR porosity datasets and the plurality of porosity tool datasets;
determining a plurality of dataset ROPs based on the plurality of porosity errors, determining a mean ROP based on the plurality of dataset ROPs, and designating the mean ROP as a second candidate ROP;
determining a mean porosity error based on the plurality of porosity errors;
determining whether the mean porosity error is minimized within the error tolerance; and
selecting the second candidate ROP as the downhole ROP in response to determining the mean porosity error is minimized within the error tolerance.

7. The method of claim 6, further comprising:
depth aligning the plurality of NMR porosity datasets and the plurality of porosity tool datasets based on a corresponding dataset ROP; and
determining the plurality of porosity errors from the depth aligned plurality of NMR porosity datasets and the depth aligned plurality of porosity tool datasets.

8. The method of claim 6, further comprising:
determining whether a surface ROP is obtained from surface equipment of the well system;
if the surface ROP is obtained, selecting the surface ROP as the second candidate ROP; and
if the surface ROP is not obtained, determining the mean ROP based on the plurality of dataset ROPs, and designating the mean ROP as the second candidate ROP.

9. The method of claim 1, wherein determining that the first NMR porosity data and the first porosity tool data minimize the first porosity error within the error tolerance includes at least one of:
determining that the first porosity error is less than other porosity errors derived from other NMR and porosity tool data associated with other NMR and neutron measurements; or
determining that the first porosity error is less than a porosity error threshold.

10. The method of claim 1, further comprising:
modifying at least one of a well operation or a well operation attribute based on the selected downhole ROP.

11. The method of claim 10, wherein:
the well operation includes at least one of an NMR well operation or an autonomous steering drilling operation; and
the well operation attribute includes at least one of an NMR well operation attribute or an autonomous steering drilling operation attribute.

12. The method of claim 1, further comprising:
after downhole determination and selection of the downhole ROP, communicating the selected downhole ROP to one or more downhole well devices.

13. The method of claim 1, wherein determining the first porosity tool data based on the first porosity tool measurements performed downhole using the porosity tool of the well system includes determining first neutron porosity data based on first neutron measurements performed downhole using a neutron tool of the well system.

14. A well system comprising:
one or more processors; and
a computer-readable storage medium having instructions stored thereon that are executable by the one or more processors to cause the well system to:
determine first nuclear magnetic resonance (NMR) porosity data based on first NMR measurements performed downhole using an NMR tool of the well system;
determine first porosity tool data based on first porosity tool measurements performed downhole using a porosity tool of the well system;
select a first candidate ROP and determining a first corrected NMR porosity data based on the selected first candidate ROP and the first NMR porosity data;
determine whether the first corrected NMR porosity data and the first porosity tool data minimize a first porosity error within an error tolerance, the first porosity error derived from a difference between the first corrected NMR porosity data and the first porosity tool data; and
select the first candidate ROP as a downhole ROP in response to determining the corrected NMR porosity data and the first porosity tool data minimize the first porosity error within the error tolerance.

15. The well system of claim 14, further comprising instructions that are executable by the one or more processors to cause the well system to:
depth align the first NMR porosity data and the first porosity tool data based on the selected first candidate ROP prior to determining the first corrected NMR porosity data.

16. The well system of claim 14, further comprising instructions that are executable by the one or more processors to cause the well system to:
in response to a determination that the first corrected NMR porosity data and the first porosity tool data do not minimize the first porosity error within the error tolerance,
select a second candidate ROP based on the first porosity error;
depth align the first NMR porosity data and the first porosity tool data based on the selected second candidate ROP;
determine a second corrected NMR porosity data based on the selected second candidate ROP and the first NMR porosity data;
determine whether the second corrected NMR porosity data and the first porosity tool data minimize a second porosity error within the error tolerance, the second porosity error derived from a difference between the second corrected NMR porosity data and the first porosity tool data; and
select the second candidate ROP as the downhole ROP in response to determining the second corrected NMR porosity data and the first porosity tool data minimize the second porosity error within the error tolerance.

17. The well system of claim 14, further comprising instructions that are executable by the one or more processors to cause the well system to:
determine whether a surface ROP is obtained from surface equipment of the well system;
if the surface ROP is obtained, select the surface ROP as the first candidate ROP; and
if the surface ROP is not obtained, determine the first candidate ROP based on a last known ROP, a predetermined ROP, or a last derived porosity error.

18. The well system of claim 14, wherein the first NMR porosity data and the first porosity tool data include a plurality of NMR porosity datasets and a plurality of porosity tool datasets, further comprising instructions that are executable by the one or more processors to cause the well system to:
determine a plurality of porosity errors from the plurality of NMR porosity datasets and the plurality of porosity tool datasets;
determine a plurality of dataset ROPs based on the plurality of porosity errors, determining a mean ROP based on the plurality of dataset ROPs, and designating the mean ROP as a second candidate ROP;
determine a mean porosity error based on the plurality of porosity errors;
determine whether the mean porosity error is minimized within the error tolerance; and
select the second candidate ROP as the downhole ROP in response to determining the mean porosity error is minimized within the error tolerance.

19. A non-transitory computer-readable storage medium having instructions stored thereon that are executable by one or more processors of a well system, the instructions comprising:
instructions for determining first nuclear magnetic resonance (NMR) porosity data based on first NMR measurements performed downhole using an NMR tool of the well system;
instructions for determining first porosity tool data based on first porosity tool measurements performed downhole using a porosity tool of the well system;
instructions for selecting a first candidate ROP and determining a first corrected NMR porosity data based on the selected first candidate ROP and the first NMR porosity data;
instructions for determining whether the first corrected NMR porosity data and the first porosity tool data minimize a first porosity error within an error tolerance, the first porosity error derived from a difference between the first corrected NMR porosity data and the first porosity tool data; and
instructions for selecting the first candidate ROP as a downhole ROP in response to determining the corrected NMR porosity data and the first porosity tool data minimize the first porosity error within the error tolerance.

20. The non-transitory computer-readable storage medium of claim 19, wherein the instructions further comprise:
instructions for depth aligning the first NMR porosity data and the first porosity tool data based on the selected first candidate ROP prior to determining the first corrected NMR porosity data.

21. The non-transitory computer-readable storage medium of claim 19, wherein the instructions further comprise:
instructions for determining whether a surface ROP is obtained from surface equipment of the well system;
if the surface ROP is obtained, instructions for selecting the surface ROP as the first candidate ROP; and
if the surface ROP is not obtained, instructions for determining the first candidate ROP based on a last known ROP, a predetermined ROP, or a last derived porosity error.
